(19) United States
(12) Patent Application Publication
(10) Pub. No.: US 2025/0330784 A1
(43) Pub. Date: Oct. 23, 2025

(54) METHOD AND APPARATUS FOR PROVIDING SENSING SERVICE, AND DEVICE AND STORAGE MEDIUM

(71) Applicant: Beijing Xiaomi Mobile Software Co., Ltd., Beijing (CN)

(72) Inventor: Yang SHEN, Beijing (CN)

(73) Assignee: Beijing Xiaomi Mobile Software Co., Ltd., Beijing (CN)

(21) Appl. No.: 18/868,328

(22) PCT Filed: May 24, 2022
(86) PCT No.: PCT/CN2022/094756

§ 371 Date: Nov. 22, 2024

(51) Int. Cl. H04W 4/38; H04W 8/22; H04W 60/04; H04W 64/00

(52) U.S. Cl. CPC H04W 4/38; H04W 8/22; H04W 60/04; H04W 64/00

(57) ABSTRACT

The present disclosure relates to the technical field of communications, and in particular provides a method and apparatus for providing a sensing service, and a device and a storage medium. The method comprises: a first core network device sending a terminal request message to a second core network device (S401), wherein the terminal request message carries location information of a sensing service; the first core network device receiving a terminal response message from the second core network device (S402), wherein the terminal response message carries terminal information of a first terminal, and the first terminal is associated with the location information; the first core network device determining a sensing terminal according to at least the terminal information of the first terminal (S403); and the first core network device sending a sensing request message to the sensing terminal (S404), wherein the sensing request message is used for requesting the sensing terminal to perform sensing processing corresponding to the sensing service. In the present disclosure, a determined terminal can be located at a specific location corresponding to a sensing service and can implement sensing processing corresponding to the sensing service, thereby implementing wireless sensing at the specific location.

### CROSS REFERENCE

The present application is a national phase application of International Application No. PCT/CN2022/094756, filed on May 24, 2022, and the entire contents thereof are incorporated herein by reference.

### TECHNICAL FIELD

The present disclosure relates to the field of communication technologies, and in particular provides a method, an apparatus, a device, and a storage medium for providing a sensing service.

### BACKGROUND

In recent years, with the continuous development and integration of wireless technologies and sensing methods, wireless sensing technology has become a hot topic of research. In particular, wireless sensing technology can be combined with communication technologies such as the fifth generation (5G) mobile communication technology to provide sensing services based on communication systems.

It should be noted that, information disclosed in the above background portion is provided only for better understanding of the background of the present disclosure, and thus it may contain information that does not form the prior art known by those ordinary skilled in the art.

### SUMMARY

The present disclosure provides a method, apparatus, device and storage medium for providing a sensing service.

According to a first aspect of the present disclosure, a method for providing a sensing service is provided. The method can be applied to a first core network device in a communication system. The above method includes: the first core network device sends a terminal request message to the second core network device, and the terminal request message carries the location information of the sensing service; the first core network device receives a terminal response message from the second core network device, and the terminal response message carries the terminal information of the first terminal, and the first terminal is associated with the location information; the first core network device determines the sensing terminal according to at least the terminal information of the first terminal; the first core network device sends a sensing request message to the sensing terminal, and the sensing request message is used to request the sensing terminal to perform sensing processing corresponding to the sensing service.

According to a second aspect of the present disclosure, a method for providing sensing service is provided. The method may be applied to a second core network device of the communication system. The above method includes: receiving, the second core network device, a terminal request message from a first core network device, wherein location information of a sensing service is carried by the terminal request message; determining, by the second core network device, a first terminal associated with the location information; sending, by the second core network device, a terminal response message to the first core network device, wherein terminal information of the first terminal is carried by the terminal response message, the terminal information of the first terminal is used by the first core network device to determine the sensing terminal, and the sensing terminal is used to perform sensing processing corresponding to the sensing service.

According to a third aspect of the present disclosure, a method for providing sensing service is provided. The method may be applied to a first core network device in the communication system. The above method includes: sending, by the first core network device, a terminal request message to a second core network device, wherein location information of a sensing service is carried by the terminal request message; receiving, by the first core network device, a terminal response message from the second core network device, wherein terminal information of a third terminal is carried by the terminal response message, and the third terminal is associated with the location information and has a sensing capability that supports the sensing service; determining, by the first core network device, a sensing terminal according to at least the terminal information of the third terminal; and sending, by the first core network device, a sensing request message to the sensing terminal, wherein the sensing request message is used to request the sensing terminal to perform sensing processing corresponding to the sensing service.

According to a fourth aspect of the present disclosure, a method for providing sensing service is provided. The method may be applied to a second core network device in the communication system. The above method includes: receiving, a second core network device, a terminal request message from a first core network device, wherein location information of a sensing service is carried by the terminal request message; determining, by the second core network device, a third terminal associated with the location information and having a sensing capability that supports the sensing service; and sending, by the second core network device, a terminal response message to the first core network device, wherein terminal information of the third terminal is carried by the terminal response message, the terminal information of the third terminal is used by the first core network device to determine the sensing terminal, and the sensing terminal is used to perform sensing processing corresponding to the sensing service.

According to a fifth aspect of the present disclosure, a method for providing sensing service is provided. The method may be applied to a terminal device in the communication system. The above method includes: receiving, by a sensing terminal, a sensing request message from a first core network device, wherein the sensing request message is used to request the sensing terminal to perform a sensing process corresponding to a sensing service, and the sensing terminal is associated with location information of the sensing service; performing, by the sensing terminal, the sensing processing; and sending, by the sensing terminal, sensing response information to the first core network device, and sensing information obtained by performing the sensing processing is carried by the sensing response information.

According to a sixth aspect of the present disclosure, an apparatus for providing sensing service is provided. The apparatus may be disposed on a first core network device. The above apparatus includes a sending module, a receiving module, and a determining module. The sending module is configured to send a terminal request message to a second core network device, wherein location information of a sensing service is carried by the terminal request message. The receiving module is configured to receive a terminal response message from the second core network device, wherein terminal information of a first terminal is carried by the terminal response message, and the first terminal is associated with the location information. The determining module is configured to determine a sensing terminal according to at least the terminal information of the first terminal. The sending module is further configured to send a sensing request message to the sensing terminal, wherein the sensing request message is used to request the sensing terminal to perform sensing processing corresponding to the sensing service.

According to a seventh aspect of the present disclosure, an apparatus for providing sensing service is provided. The apparatus may be disposed on a second core network device. The above apparatus includes a receiving module, a determining module, and a sending module. The receiving module is configured to receive a terminal request message from a first core network device, wherein location information of a sensing service is carried by the terminal request message. The determining module is configured to determine a first terminal associated with the location information. The sending module is configured to send a terminal response message to the first core network device, wherein terminal information of the first terminal is carried by the terminal response message, the terminal information of the first terminal is used by the first core network device to determine the sensing terminal, and the sensing terminal is used to perform sensing processing corresponding to the sensing service.

According to an eighth aspect of the present disclosure, an apparatus for providing sensing service is provided. The apparatus may be disposed on a first core network device. The above apparatus includes a sending module, a receiving module, and a determining module. The sending module is configured to send a terminal request message to a second core network device, wherein location information of a sensing service is carried by the terminal request message. The receiving module is configured to receive a terminal response message from the second core network device, wherein terminal information of a third terminal is carried by the terminal response message, and the third terminal is associated with the location information and has a sensing capability that supports the sensing service. The determining module is configured to determine a sensing terminal according to at least the terminal information of the third terminal. The sending module is further configured to send a sensing request message to the sensing terminal, wherein the sensing request message is used to request the sensing terminal to perform sensing processing corresponding to the sensing service.

According to a ninth aspect of the present disclosure, an apparatus for providing sensing service is provided. The apparatus may be disposed on a second core network device. The above apparatus includes a receiving module, a determining module, and a sending module. The receiving module is configured to receive a terminal request message from a first core network device, wherein location information of a sensing service is carried by the terminal request message. The determining module is configured to determine a third terminal associated with the location information and having a sensing capability that supports the sensing service. The sending module is configured to send a terminal response message to the first core network device, wherein terminal information of the third terminal is carried by the terminal response message, the terminal information of the third terminal is used by the first core network device to determine the sensing terminal, and the sensing terminal is used to perform sensing processing corresponding to the sensing service.

According to a tenth aspect of the present disclosure, an apparatus for providing sensing service is provided. The apparatus may be disposed on a terminal device. The above apparatus includes a receiving module, a processing module, and a sending module. The receiving module is configured to receive a sensing request message from a first core network device, wherein the sensing request message is used to request the sensing terminal to perform a sensing process corresponding to a sensing service, and the sensing terminal is associated with location information of the sensing service. The processing module is configured to perform the sensing processing. The sensing module is configured to send sensing response information to the first core network device, and sensing information obtained by performing the sensing processing is carried by the sensing response information.

According to an eleventh aspect of the present disclosure, a core network device is provided. The above core network device includes: a memory, configured to store computer executable instructions; and a processor, connected to the memory and configured to execute the computer executable instructions stored on the memory to implement the method according to any one of the first aspect to the fourth aspect and their possible implantations.

According to a twelfth aspect of the present disclosure, a terminal is provided. The above terminal includes: a memory, configured to store computer executable instructions; and a processor, connected to the memory and configured to execute the computer executable instructions stored on the memory to implement the method according to any one of the fifth aspect and its possible implantations.

According to a thirteenth aspect of the present disclosure, a computer readable storage medium is provided, the computer readable storage medium has computer executable instructions stored therein; when the computer executable instructions are executable by a processor in a computer, the method according to any one of the first aspect to the fifth aspect and their possible implantations is implemented.

According to a fourteenth aspect of the present disclosure, a computer program or a computer program product is provided. When the computer program product is executed on a computer, the computer implements a method as described in any one of the first to fifth aspects and possible implementations thereof.

It is to be understood that both the foregoing general description and the following detailed description are exemplary and explanatory only and are not restrictive of the present disclosure.

### BRIEF DESCRIPTION OF THE DRAWINGS

FIG. 1 is a schematic diagram of the architecture of a 5G communication system in an embodiment of the present disclosure.

FIG. 2 is a schematic diagram of an interaction flow of a method for providing sensing service according to an embodiment of the present disclosure.

FIG. 3 is a schematic diagram of an interaction flow of another method for providing sensing service according to an embodiment of the present disclosure.

FIG. 4 is a flowchart of a first example of a method for providing sensing service in an embodiment of the present disclosure.

FIG. 5 is a flow chart of a second example of a method for providing sensing service in an embodiment of the present disclosure.

FIG. 6 is a flowchart of a third example of a method for providing sensing service in an embodiment of the present disclosure.

FIG. 7 is a flowchart of a fourth example of a method for providing sensing service in an embodiment of the present disclosure.

FIG. 8 is a flowchart of a fifth example of a method for providing sensing service in an embodiment of the present disclosure.

FIG. 9 is a schematic structural diagram of an example of an apparatus for providing sensing service in an embodiment of the present disclosure.

FIG. 10 is a schematic diagram of the structure of a communication device in an embodiment of the present disclosure.

FIG. 11 is a schematic diagram of the structure of a terminal device in an embodiment of the present disclosure.

FIG. 12 is a schematic diagram of the structure of a network device in an embodiment of the present disclosure.

### DETAILED DESCRIPTION

Exemplary embodiments will be described in detail herein, examples of which are shown in the accompanying drawings. When the following description refers to the drawings, unless otherwise indicated, the same numbers in different drawings represent the same or similar elements. The implementations described in the following exemplary embodiments do not represent all implementations consistent with the embodiments of the present disclosure. Instead, they are merely examples of devices and methods consistent with some aspects of the embodiments of the present disclosure as detailed in the appended claims.

The terms used in the disclosed embodiments are only for the purpose of describing specific embodiments and are not intended to limit the disclosed embodiments. The singular forms of “a”, “an” and “the” used in the disclosed embodiments and the appended claims are also intended to include plural forms unless the context clearly indicates other meanings. It should also be understood that the term “and/or” used herein refers to and includes any or all possible combinations of one or more associated listed items.

It should be understood that although the terms “first”, “second”, “third”, etc. may be used to describe various information in the embodiments of the present disclosure, such information should not be limited to these terms. These terms are only used to distinguish the same type of information from each other. For example, without departing from the scope of the embodiments of the present disclosure, “first information” may also be referred to as “second information”, and similarly, “second information” may also be referred to as “first information”. Depending on the context, the word “if” as used herein may be interpreted as “at the time of” or “when” or “in response to determination”.

Furthermore, in the description of the embodiments of the present disclosure, “and/or” is only a description of the association relationship of the associated objects, indicating that three relationships may exist. For example, A and/or B can represent: A exists alone, A and B exist at the same time, and B exists alone. In addition, in the description of the embodiments of the present disclosure, “a plurality of” can refer to two or more than two.

The technical solution of the disclosed embodiment relates to an architecture of a communication system. The communication system may be a 5G communication system or a future evolution communication system. In the architecture of the communication system, there are a first core network device, a second core network device and a terminal device. The first core network device is located in the core network. Also, a communication interface may be provided between the first core network device and other core network devices. The first core network device has at least the following functions: completing the registration of a terminal device with wireless sensing capability; triggering a sensing service according to a sensing request message; and managing the sensing service. The terminal device with wireless sensing capability can realize communication transmission and wireless sensing through an antenna.

Hereinafter, the embodiments of the present disclosure will be explained and illustrated by taking the 5G communication system as an example. It should be noted that the embodiments of the present disclosure are also applicable to any future evolution communication system after the 5G communication system.

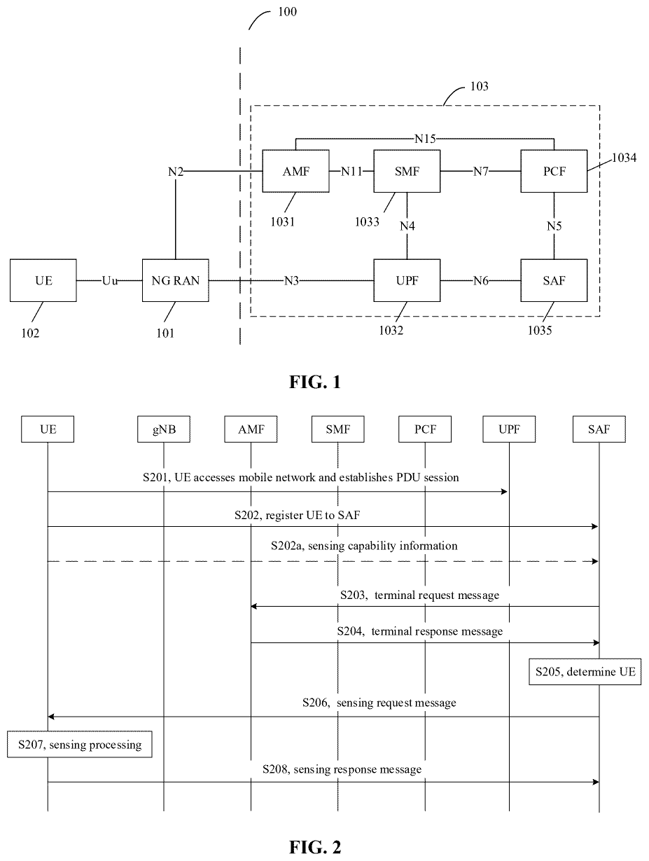

FIG. 1 is a schematic diagram of the architecture of a 5G communication system in an embodiment of the present disclosure. As shown in FIG. 1, the above-mentioned 5G communication system 100 may include a 5G radio access network (RAN) and a 5G core network (5GC). The 5G radio access network may include a next generation radio access network (NG RAN). The NG RAN 101 communicates with a terminal device (or terminal) 102 via a Uu interface. The 5G core network 103 may include: an access and mobility management function (AMF) 1031, a user plane function (UPF) 1032, a session management function (SMF) 1033, a policy control function (PCF) 1034, a sensing application function (SAF) 1035, etc. In the embodiment of the present disclosure, the above-mentioned communication system may also include other network elements, which are not specifically limited in the embodiment of the present disclosure.

In the 5G communication system 100, the following interfaces are set between the various functional entities:
N7 is the interface between PCF and SMF, which is used to deliver control policies for packet data unit (PDU) session granularity and service data flow granularity.
N3 is the communication interface between UPF and NG RAN.
N15 is the interface between PCF and AMF, which is used to deliver UE policies and access control related policies.
N4 is the interface between SMF and UPF, which is used to transmit information between the control plane and the user plane, including the control plane instructing the forwarding rules, QOS control rules, traffic statistics rules, etc. to the user plane and the reporting of information of the user plane.
N11 is the interface between SMF and AMF, which is used to transfer PDU session information between RAN and UPF, transfer control messages sent to UE, transfer radio resource control information sent to NG RAN, etc.
N2 is the interface between AMF and NG RAN, which is used to transmit radio bearer control information from the core network side to NG RAN.
N1 is the interface between AMF and UE, which is irrelevant to access, and is used to deliver QoS control rules, etc. to UE.
N5 is the interface between PCF and SAF.
N6 is the interface between UPF and SAF.

The terminal device may be a terminal device with wireless communication function and wireless sensing function, and may also be called user equipment (UE). The terminal device may be deployed on land, including indoor or outdoor, handheld, wearable or vehicle-mounted; it may also be deployed on the water surface (such as ships, etc.); it may also be deployed in the air (such as airplanes, balloons and satellites, etc.). The terminal device may be a mobile phone, a tablet computer, a computer with wireless transceiver function, a virtual reality (VR) terminal device, an augmented reality (AR) terminal device, a wireless terminal in industrial control, a wireless terminal in self-driving, a wireless terminal in remote medical, a wireless terminal in smart grid, a wireless terminal in transportation safety, a wireless terminal in smart city, a wireless terminal in smart home, etc. The terminal device may also be a handheld device with wireless communication function and wireless sensing function, a vehicle-mounted device, a wearable device, a computing device or other processing device connected to a wireless modem, etc. Optionally, the terminal device may be called different names in different networks, such as: terminal device, access terminal, user unit, user station, mobile station, mobile site, remote station, remote terminal, mobile device, user terminal, terminal, wireless communication device, user agent or user device, cellular phone, cordless phone, session initiation protocol (SIP) phone, wireless local loop (WLL) station, personal digital assistant (PDA), terminal equipment in 5G communication system or future evolution communication system, etc.

The access network device may be a device on the access network side for supporting communication terminals to access the wireless communication system. For example, it may be a next generation NodeB (gNB), a transmission reception point (TRP), a relay node, an access point (AP), etc. in a 5G communication system. In the embodiment of the present disclosure, the access network device has a wireless sensing function.

It should be noted that in the communication system shown in FIG. 1, the functions and interfaces of each device are only exemplary, and not all functions of each device are essential when applied in the embodiments of the present disclosure. All or part of the devices of the core network may be physical entity devices or virtualized devices, which are not limited here. Of course, the communication system in the embodiments of the present disclosure may also include other devices not shown in FIG. 1, which are not limited here.

Continuing to refer to FIG. 1, as the first core network device in the embodiment of the present disclosure, SAF is an entity deployed in a data network (DN). SAF has the following functions: completing the registration of terminal devices with wireless sensing capabilities; initiating and managing sensing services. The interface between SAF and UPF is the N6 interface, and the interface between SAF and PCF is the N5 interface.

In actual applications, SAF can be provided by a mobile operator, or can be trusted by a mobile operator. In the latter case, there is a trusted business and technical partnership between the owner of SAF and the mobile operator. For a sensing service requester that needs to request a wireless sensing service based on a communication system to implement its own service, the sensing service requester needs to first send a sensing request to SAF. After receiving the sensing request from the sensing service requester, SAF initiates a wireless sensing service and requests the corresponding UE to perform wireless sensing processing. In one embodiment, a wireless sensing client can be installed on the UE. The wireless sensing client registers the UE to the SAF. Afterwards, after learning about the wireless sensing service initiated by the SAF, the wireless sensing client calls the UE's hardware (including a transmitter and a receiver) to perform wireless sensing processing, and sends the sensing information obtained by the wireless sensing processing to the SAF. The sensing information may include sensing data and/or sensing results.

Therefore, the sensing service requester needs to request the SAF to provide it with wireless sensing services. However, the existing communication system does not support providing sensing services to these sensing service requesters.

It should be noted that, in the present disclosure, sensing and wireless sensing, as well as sensing service and wireless sensing service have the same meaning, and thus can be used interchangeably.

In order to solve the above problems, based on the architecture of the 5G communication system shown in FIG. 1, an embodiment of the present disclosure provides a method for providing sensing services.

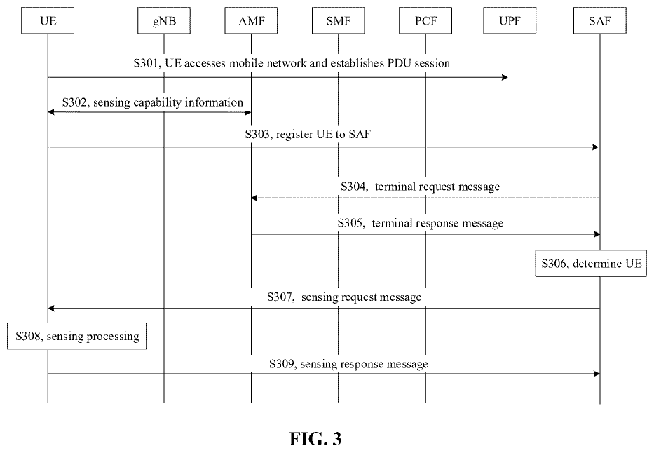

In the embodiments of the present disclosure, in the embodiments of the following FIGS. 2 and 3, the first core network device in the communication system can be an SAF entity (or device) for sensing application function, the second core network device can be an AMF entity (or device) for access and mobility management function, and the terminal device can be a UE for example, to illustrate the method for providing sensing service proposed in the embodiments of the present disclosure. In the 5G communication system and its evolved versions, the first core network device, the second core network device and the terminal device may also be other entities or functional modules with the same or similar functions and connection relationships, which are not limited in the embodiments of the present disclosure.

FIG. 2 is a schematic diagram of an interaction flow of a method for providing sensing service according to an embodiment of the present disclosure. As shown in FIG. 2, in this embodiment, the method for providing sensing service may include S201 to S208.

S201, UE accesses the mobile network and establishes a PDU session with UPF.

In the embodiment, the process of UE accessing the mobile network complies with the existing 5G standard protocol, and the specific details can be referred to the protocol document 3GPP TS 23.502.

In the embodiment, after the UE accesses the mobile network, the UE can initiate the PDU session establishment process. In this way, a PDU session is established between the UE and the UPF. The PDU session establishment process can refer to the standard document 3GPP TS 23.502. It can be understood that the PDU session established between the UE and the UPF is transparently transmitted on the gNB. In addition, during the PDU session establishment process, the SMF allocates an IP address to the UE.

It should be noted that, based on the established PDU session, the UE can implement IP-based transmission. In one embodiment, IP-based transmission can be performed between the UE and the SAF.

S202, register UE to SAF.

In the embodiment, in order to register with the SAF, the UE sends a registration request message to the SAF. The registration request message is used to initiate a registration process to the SAF. After receiving the registration request message, the SAF registers the UE and sends a registration response message to the UE. In one embodiment, if the SAF completes the registration, the SAF sends a registration response message to the UE to indicate that the registration is complete. In one embodiment, if the SAF cannot complete the registration of the UE, the SAF sends a registration response message to the UE to indicate that the registration failed. In this case, the registration response message may carry the cause for the registration failure.

In one embodiment, the above-mentioned registration request message carries at least the terminal information of the UE. The terminal information of the UE may include at least one of the following: UE identification information, the IP address of the UE, and the sensing capability information. In one example, the terminal information of the UE may include the UE identification information and the IP address. In one example, the terminal information of the UE may include the UE identification information, the IP address, and the sensing capability information. In one example, the terminal information of the UE may include the UE identification information and the sensing capability information. Of course, the terminal information of the UE may also include other information, which is not specifically limited in the embodiments of the present disclosure.

The UE identification information is used to identify the UE. In one example, the UE identification information may be a UE identifier (UE ID), for example, a general public subscription identifier (GPSI), a subscription permanent identifier (SUPI), a mobile station international ISDN number (MSISDN), etc. It can be understood that the UE identification information may also be any other information used to identify the UE, and the embodiments of the present disclosure do not specifically limit this.

It should be noted that the UE can send a registration request message to the UPF through the PDU session and via the gNB, and the UPF then forwards the registration request message to the SAF. Specifically, the registration request message may include the IP address of the SAF for addressing. In this case, the UE sends the registration request message to the gNB through the PDU session via the Uu interface; the gNB transparently transmits the registration request message in the PDU session, that is, sends the registration request message to the UPF through the N3 interface; thereafter, the UPF receives the registration request message through the N3 interface and forwards the registration request message to the SAF corresponding to the IP address through the N6 interface. In addition, the registration request message may also include the IP address of the UE. In this way, the SAF can obtain the IP address of the UE that is registering. Accordingly, based on the IP address of the UE, the SAF sends the registration response message to the UPF, and the UPF then sends the registration response message to the UE via the gNB.

When the UE is registered to the SAF, the UE can inform the SAF of its own sensing capability. Specifically, the UE can send sensing capability information to the SAF. The sensing capability information is used to indicate the sensing capability of the UE. In one embodiment, when the UE sends a registration request message to the SAF, the sensing capability information is carried in the registration request message. It can be understood that the sensing capability of the UE includes but is not limited to: sensing type, sensing range, available sensing time, sensing accuracy, and sensing data processing capability. It can be understood that the sensing capability can also include any other capability information, which is not specifically limited in the embodiments of the present disclosure.

S202a, UE sends sensing capability information to SAF.

In the embodiment, the UE sends a sensing capability notification message to the SAF, and the sensing capability notification message carries the sensing capability information of the UE.

It is understandable that if the SAF does not obtain the UE's sensing capability information during the UE registration process with the SAF in S202, the UE may send a sensing capability notification message to the SAF after the UE is registered to the SAF. In one example, the UE may send the sensing capability notification message to the SAF through a PDU session based on the SAF's IP address.

It is understandable that the UE's sensing capability includes but is not limited to: sensing type, sensing range, available sensing time, sensing accuracy, and sensing data processing capability. Of course, the sensing capability may also include any other capability information, which is not specifically limited in the embodiments of the present disclosure.

It can be seen that if the SAF obtains the sensing capability information of the UE in S202, S202a may not be executed.

It should be noted that the UE access and establishment of the PDU session in S201, the UE registration in S202, and the UE sending the sensing capability information to the SAF in S202a do not need to be performed every time the present embodiment is implemented. Generally, after the UE completes S201, S202 and S202a for the first time, these steps may not be performed in the subsequent process of providing sensing services. In addition, when the UE executes S201 and S202 again, S202a is executed.

At this point, the UE is registered to the SAF.

In some possible embodiments, after completing the above steps, the UE is successfully registered to the SAF, so that the SAF can subsequently initiate and manage the sensing service. It is understandable that the process of the SAF selecting the UE and requesting the selected UE to perform wireless sensing does not necessarily require the UE to be registered or the SAF to obtain the sensing capability information. In the case where the UE has been registered on the SAF and the sensing capability information of the UE has been saved, the method of the embodiment of the present disclosure can start with S203 without executing S201 to S202a. S203, SAF sends a terminal request message to AMF via PCF.

The terminal request message carries the location information of the sensing service.

It should be noted that the SAF first needs to receive a service request message from the sensing service requester. The service request message is used to request the SAF to initiate the corresponding sensing service. The service request message may carry relevant information about the sensing service. In one embodiment, the relevant information may include the location targeted by the sensing service. In one embodiment, the relevant information may include the service type of the sensing service. In one embodiment, the relevant information may also include requirement information for the sensing service. Of course, the relevant information may also include any other information, which is not specifically limited in the embodiments of the present disclosure.

The specific process of SAF sending a terminal request message to AMF via PCF is as follows: SAF sends a terminal request message to PCF through the N5 interface; PCF determines the corresponding AMF based on the location information in the terminal request message, and forwards the terminal request message to AMF through the N15 interface.

In the embodiment, the location information may be obtained according to the service request message. In one embodiment, the SAF may use the location indicated by the relevant information in the sensing request message as the location information in the terminal request message. In one embodiment, the SAF may obtain the location information in the terminal request message from the SAF local or other device according to the location indicated by the relevant information in the sensing request message.

It can be understood that the location information of the sensing service is used to indicate the location targeted by the sensing service. Specifically, the location information of the sensing service can be cell identification information or tracking area identification information. The cell identification information is used to indicate a specific location, that is, a cell. In one embodiment, the cell identification information can be a cell identifier (Cell ID). In this case, the AMF is an AMF that provides services for the cell identified by the cell identification information. The tracking area identification information is used to indicate a specific area, that is, a tracking area. In one embodiment, the tracking area identification information can be a tracking area identity (TAI). In this case, the AMF is an AMF that provides services for the tracking area identified by the tracking area identification information. It can be understood that the location information of the sensing service can also be any other location information, and the embodiments of the present disclosure do not specifically limit this.

S204, AMF sends a terminal response message to SAF via PCF.

The terminal response message carries the terminal information of the terminal device associated with the location information.

After receiving the terminal request message in S203, the AMF obtains the location information in the terminal request message, determines the location indicated by the location information, and determines the UE located at the location, that is, the first UE (also referred to as the first terminal). Afterwards, the AMF sends the terminal information of the first UE to the PCF through a terminal response message, and the PCF forwards the terminal response message to the SAF.

It can be understood that the first UE may be one or more UEs located at the location. In one example, the first UE may be all UEs located at the location. In one example, the first UE may be some UEs among all UEs located at the location.

In one embodiment, after determining the first UE, the AMF may further generate terminal information of the first UE. The terminal information may be UE identification information of the first UE. The generated terminal information may be in the form of a list. Specifically, the terminal information may be a terminal list including the terminal information of the first UE.

S205, SAF determines the UE.

In the embodiment, after the SAF receives the terminal response message in S204, the SAF determines a UE for performing the sensing process corresponding to the sensing service, namely, a sensing UE (also called a sensing terminal).

It is understandable that the SAF stores the terminal information of the UE that has been registered to the SAF. The UE registered to the SAF is the second UE (also referred to as the second terminal). The number of the second UE may be one or more. The terminal information of the second UE may include at least one of the following: UE identification information, IP address, and sensing capability information.

In one embodiment, the terminal information of the second UE may include UE identification information, IP address, and sensing capability information. In this case, after the SAF obtains the terminal response message, the SAF determines at least one UE in the second UE that is the same as the first UE based on the terminal information of the first UE; and the SAF determines a UE with a sensing capability to support the sensing service in the at least one UE as the sensing UE based on the sensing capability information of the at least one UE.

It can be understood that the number of determined sensing UEs can be one or more. In one example, the number of UEs determined to have sensing capabilities supporting sensing services is one, and the UE is used as a sensing UE. In one example, the number of UEs determined to have sensing capabilities supporting sensing services is multiple. In this case, the SAF can use all UEs with sensing capabilities supporting sensing services as the sensing UE; or, after determining the UEs with sensing capabilities supporting sensing services, the SAF can further select a UE from these UEs as the sensing UE. For example, the SAF can randomly select a UE from these UEs as the sensing UE. For another example, the SAF can use the UE with the strongest sensing capabilities in one or more aspects as the sensing UE.

In one embodiment, the terminal information of the second UE may include UE identification information and an IP address. In this case, after the SAF obtains the terminal response message, the SAF determines at least one UE in the second UE that is the same as the first UE based on the terminal information of the first UE; and the SAF determines the sensing UE in the at least one UE.

It can be understood that the number of the determined sensing UEs may be one or more. In one example, the SAF may randomly select a UE from at least one UE as the sensing UE. In one example, the SAF may select all of the at least one UE as the sensing UE.

In one embodiment, after determining the UE, the SAF may further determine the IP address of the UE based on the UE identification information. Specifically, after the SAF determines the UE identification information, the SAF may obtain the IP address corresponding to the UE identification information according to the UE identification information.

S206, SAF sends a sensing request message to the UE via UPF and gNB.

In the embodiment, after the SAF determines the UE in S205, the SAF sends a sensing request message to the UE. Specifically, the SAF sends a sensing request message to the UPF; the UPF then sends the sensing request message to the gNB; finally, the gNB sends the sensing request message to the UE. The sensing request message is used to request the UE to perform sensing processing. The sensing request message carries at least sensing service information and the IP address of the UE. The sensing service information is used to indicate the need for sensing processing. In one example, the sensing request message may also include UE identification information.

It should be noted that the sensing request message sent by the SAF can reach the gNB in the following ways but is not limited to. The SAF sends the sensing request message to the UPF through the N6 interface; after receiving the sensing request message, the UPF forwards the sensing request message to the gNB via the N3 interface through the PDU session. Specifically, the SAF can send the sensing request message to the UPF according to the IP address of the UE. Subsequently, the UPF determines the corresponding PDU session based on the UE identification information obtained in the sensing request message, or the UE identification information found according to the IP address, or the IP address, and sends the sensing request message to the UE through the determined PDU session. In this case, the sensing request message will first arrive at the gNB. After the gNB receives the sensing request message from the SAF, the gNB continues to transmit the sensing request message to the UE through the Uu interface through the PDU session.

It can be understood that the gNB is transparent to the PDU session between the UE and the UPF. In other words, the gNB uses transparent transmission to transmit the sensing request message between the UPF and the UE.

S207, UE performs sensing processing.

In the embodiment, after the UE receives the sensing request message from the SAF in S206, the UE can perform sensing processing according to the sensing service information in the sensing request message.

It can be understood that the UE can perform corresponding sensing processing based on the sensing service information.

In one embodiment, the UE may determine the sensing requirement of the sensing service according to the sensing service information in the indication information. The sensing requirement may include sensing range, sensing type, sensing time, content of sensing information, sensing accuracy, etc.

The sensing range may be the range of the coverage area where the UE performs sensing processing. For example, if the coverage area where the UE performs sensing processing is substantially circular, the sensing range may refer to the diameter or radius of the coverage area. For another example, if the coverage area where the UE performs sensing processing is substantially fan-shaped, the sensing range may refer to the radius and angle of the coverage area.

The sensing type may be the type of the sensing object targeted by the UE when performing sensing processing. For example, the sensing type may be human flow sensing. For another example, the sensing type may be posture sensing. For another example, the sensing type may be environment sensing.

It should be noted that the sensing time may be the time for the UE to perform the sensing processing. For example, if the sensing service information indicates to perform one sensing, the sensing time may include the start time and the end time, or the start time and the duration. For another example, if the sensing service information indicates to perform multiple sensings, the sensing time may include at least one of the following: the number of sensings, the sensing frequency, the sensing interval, the start time and the end time of each sensing, and the start time and the duration of each sensing.

The content of the sensing information may include sensing data or sensing results. Sensing data is the original data obtained by the UE through sensing processing. The sensing result is the processing result obtained by the UE through data processing of the original data. For example, if the sensing type is human flow sensing, the sensing data may be signal data obtained by sensing people in the coverage area, and the sensing result may be human flow statistics data or heat map data obtained by data processing of the signal data.

The sensing accuracy may be the accuracy of the sensing information obtained by the UE through the sensing processing. For example, the sensing accuracy may refer to the accuracy of the sensing information. For another example, the sensing accuracy may refer to the accuracy of the hardware device that performs the sensing processing.

It can be understood that the sensing requirement may also include any other requirement information, which is not specifically limited in the embodiments of the present disclosure.

Further, after the UE determines the sensing requirement, the UE performs sensing processing according to the sensing requirement.

In one embodiment, after the UE performs the sensing process, the UE may obtain the sensing data. The sensing data may be the original data obtained by the UE after the sensing process. For example, when sensing the flow of people, the original data may be the original wireless signal received by the UE.

In one embodiment, after the UE obtains the sensing data, the UE may also perform data processing on the sensing data to obtain a sensing result of the sensing processing. For example, when sensing the flow of people, the sensing result may be data processing on the original wireless signal to obtain statistical data or heat map data of the flow of people.

S208, UE sends a sensing response message to SAF through gNB and UPF.

In the embodiment, the UE can send a sensing response message to the SAF according to the IP address of the SAF. Specifically, the UE first sends a sensing response message to the gNB; the gNB then transmits the sensing response message to the UPF in a transparent manner based on the sensing response message; then, the UPF forwards the sensing response message to the SAF. Specifically, after receiving the sensing response message from the UE through the PDU session, the UPF can forward the sensing response message to the SAF through the N6 interface.

It can be understood that the above sensing response message can carry sensing information.

It should be noted that after the SAF receives the sensing response message in S208, the SAF can obtain the sensing information.

In one embodiment, if the sensing information is a sensing result, the SAF directly obtains the sensing result. In one embodiment, if the sensing information is sensing data, the SAF may perform data processing on the sensing data to obtain the sensing result.

It is understandable that after obtaining the sensing information, the SAF can also verify the sensing information. For example, the SAF can verify whether the obtained sensing information meets the preset requirements or the requirements of the sensing service. If the SAF verifies that the obtained sensing information meets the preset requirements and the requirements of the sensing service, the sensing result obtained from the sensing information is used as the final sensing result.

If the SAF verifies that the obtained sensing information does not meet the preset requirements or the requirements of the sensing service, S203 to S209 are repeated to determine a new sensing UE and obtain a new sensing result through the new sensing UE.

At this point, the process of implementing the sensing service of the communication system is completed.

It should be noted that, in the method for providing sensing service shown in FIG. 2, the first terminal refers to the UE located at the location determined by the AMF based on the location information from the SAF; the second terminal refers to the UE that has been registered to the SAF; and the sensing terminal refers to the UE determined by the SAF to perform sensing processing.

In the embodiment described above with reference to FIG. 2, the sensing capability information of the UE is stored in the SAF, and the SAF determines the UE to be sensed based on the sensing capability information.

In an embodiment of the present application, the UE's sensing capability information may also be stored in the AMF, and the AMF generates and sends the UE's device information to the SAF based on the location information and the sensing capability information. FIG. 3 is a schematic diagram of an interaction flow of another method for providing sensing services in an embodiment of the present disclosure. As shown in FIG. 3, in this embodiment, the method for providing sensing services may include S301 to S309.

S301, UE accesses the mobile network and establishes a PDU session with UPF.

It should be noted that the execution process of S301 is similar to the execution process of S201. The execution process of S301 can refer to the specific description of S201, which will not be repeated here.

S302, UE reports sensing capability information to AMF.

The UE sends a sensing capability reporting message to the AMF, the sensing capability reporting message carries the UE's sensing capability information, and the sensing capability information is used to indicate the UE's sensing capability; and the UE receives a sensing capability response message from the AMF.

It can be understood that the UE sends a sensing capability reporting message to the gNB, and the gNB forwards the sensing capability reporting message to the AMF.

It is understandable that the UE's sensing capability includes but is not limited to: sensing type, sensing range, available sensing time, sensing accuracy, and sensing data processing capability. It is understandable that the sensing capability may also include any other capability information, which is not specifically limited in the embodiments of the present disclosure.

S303, UE registers to SAF.

In the embodiment, in order to register to the SAF, the UE sends a registration request message to the SAF. The registration request message is used to initiate a registration process to the SAF. After receiving the registration request message, the SAF registers the UE and sends a registration response message to the UE. In one embodiment, if the SAF completes the registration, the SAF sends a registration response message to the UE to indicate that the registration is complete. In one embodiment, if the SAF cannot complete the registration of the UE, the SAF sends a registration response message to the UE to indicate that the registration failed. In this case, the registration response message may carry the cause for the registration failure.

In one embodiment, the registration request message carries at least the terminal information of the UE. The terminal information of the UE may include at least one of the following: UE identification information, and the IP address of the UE. In one example, the terminal information of the UE may include the UE identification information and the IP address. Of course, the terminal information of the UE may also include other information, which is not specifically limited in the embodiment of the present disclosure.

The UE identification information is used to identify the UE. In one example, the UE identification information may be a UE identifier (UE ID), for example, a general public subscription identifier (GPSI), a subscription permanent identifier (SUPI), a mobile station international ISDN number (MSISDN), etc. It can be understood that the UE identification information may also be any other information used to identify the UE, and the embodiments of the present disclosure do not specifically limit this.

It should be noted that the UE can send a registration request message to the UPF through the PDU session and via the gNB, and the UPF then forwards the registration request message to the SAF. Specifically, the registration request message may include the IP address of the SAF for addressing. In this case, the UE sends the registration request message to the gNB through the PDU session via the Uu interface; the gNB transparently transmits the registration request message in the PDU session, that is, sends the registration request message to the UPF through the N3 interface; thereafter, the UPF receives the registration request message through the N3 interface and forwards the registration request message to the SAF corresponding to the IP address through the N6 interface. In addition, the registration request message may also include the IP address of the UE. In this way, the SAF can obtain the IP address of the UE that is registering. Accordingly, based on the IP address of the UE, the SAF sends the registration response message to the UPF, and the UPF then sends the registration response message to the UE via the gNB.

At this point, the UE is registered to the SAF.

It should be noted that the access of the UE and the establishment of the PDU session in S301, the sending of the sensing capability reporting information by the UE to the AMF in S302, and the registration of the UE in S303 do not need to be performed every time the present embodiment is implemented. Generally, after the UE completes S301, S302 and S303 for the first time, these steps may not be performed in the subsequent process of providing sensing services.

S304, SAF sends a terminal request message to AMF via PCF.

It should be noted that the execution process of S304 is similar to the execution process of S203. The execution process of S304 can refer to the specific description of S203, which will not be repeated here.

S305, AMF sends a terminal response message to SAF via PCF.

In the embodiment, the terminal response message carries the terminal information of a UE associated with the location information and having the sensing capability to support the sensing service. This UE is a third UE (also referred to as a third terminal).

After receiving the terminal request message in S304, the AMF obtains the location information in the terminal request message, determines the location indicated by the location information, and determines the UE located at the location. After that, the AMF further determines the third UE according to the sensing capability of the determined UE. The AMF sends the terminal information of the third UE to the PCF through the terminal response message, and the PCF forwards the terminal response message to the SAF.

It can be understood that the third UE may be one or more UEs located at the location and having the sensing capability to support the sensing service. In one example, the third UE may be all UEs located at the location and having the sensing capability to support the sensing service. In one example, the third UE may be part of all UEs located at the location and having the sensing capability to support the sensing service.

In one embodiment, after determining the third UE, the AMF may further generate terminal information of the third UE. The terminal information may be UE identification information of the third UE. The generated terminal information may be in the form of a list. Specifically, the terminal information may be a terminal list including the terminal information of the third UE.

S306, SAF determines the UE.

In the embodiment, after the SAF receives the terminal response message in S305, the SAF determines a UE for performing a sensing process corresponding to the sensing service, namely, a sensing UE (also called a sensing terminal).

It can be understood that the SAF stores the terminal information of the UE that has been registered to the SAF. The UE registered to the SAF is the second UE (also referred to as the second terminal). The number of the second UE may be one or more. The terminal information of the second UE may include at least one of the following: UE identification information, IP address.

In one embodiment, the terminal information of the second UE may include UE identification information and IP address. In this case, after the SAF obtains the terminal response message, the SAF determines at least one UE in the second UE that is the same as the third UE according to the terminal information of the third UE as the sensing UE.

It can be understood that the number of determined sensing UEs may be one or more. In one example, the number of the same UEs in the second UE and the third UE is one, and the SAF may use the UE as the sensing UE. In one example, the number of the same UEs in the second UE and the third UE is multiple. In this case, the SAF may use all of the multiple UEs as sensing UEs; or, the SAF may determine one of the multiple UEs as the sensing UE. For example, the SAF may randomly select one of the multiple UEs as the sensing UE.

In one embodiment, after determining the UE, the SAF may further determine the IP address of the UE based on the UE identification information. Specifically, after the SAF determines the UE identification information, the SAF may acquire the IP address corresponding to the UE identification information according to the UE identification information.

S307, SAF sends a sensing request message to the UE via UPF and gNB.

S308, UE performs sensing processing.

S309, UE sends a sensing response message to SAF through gNB and UPF.

It should be noted that the execution process of S307 to S309 is similar to the execution process of S206 to S208. The execution process of S307 to S309 can refer to the specific description of S206 to S208, which will not be repeated here.

At this point, the process of implementing the sensing service of the communication system is completed.

In an embodiment of the present disclosure, a terminal for performing wireless sensing is determined based on the location information of the sensing service and the sensing capability information of the terminal, so that the determined terminal can be in a specific location corresponding to the sensing service and implement sensing processing corresponding to the sensing service, thereby realizing wireless sensing at the specific location.

It should be noted that in the method for providing sensing services shown in FIG. 3, the third terminal refers to the UE located at the location and having the sensing capability to support the sensing service, which is determined by the AMF based on the location information from the SAF and the locally stored sensing capability information; the second terminal refers to the UE that has been registered to the SAF; the sensing terminal refers to the UE determined by the SAF to perform sensing processing.

Based on the same inventive concept, the embodiment of the present disclosure also provides a method for providing sensing services.

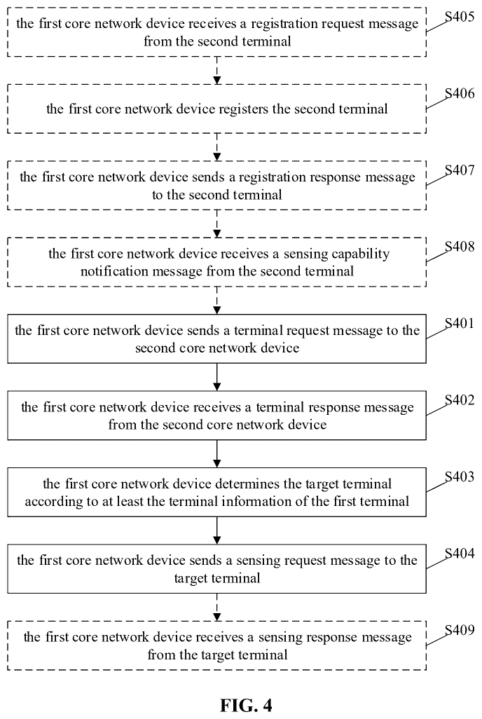

FIG. 4 is a flowchart of a first example of a method for providing sensing service in an embodiment of the present disclosure. Referring to FIG. 4, an embodiment of the present disclosure provides a method for providing sensing service, which is applied to a first core network device. The method includes the steps shown in FIG. 4.

S401, the first core network device sends a terminal request message to the second core network device.

In the embodiment, the terminal request message carries the location information of the sensing service.

S402, the first core network device receives a terminal response message from the second core network device.

In the embodiment, the terminal response message carries terminal information of the first terminal, and the first terminal is associated with the location information.

S403, the first core network device determines the sensing terminal according to at least the terminal information of the first terminal.

S404, the first core network device sends a sensing request message to the sensing terminal.

In the embodiment, the sensing request message is used to request the sensing terminal to perform sensing processing corresponding to the sensing service.

In some possible implementations, operation S403 of the first core network device determining the sensing terminal based on terminal information of at least the first terminal may include: the first core network device obtains terminal information of the second terminal, where the second terminal is a terminal registered to the first core network device; the first core network device determines the sensing terminal based on the terminal information of the first terminal and the terminal information of the second terminal.

In some possible implementations, the terminal information of the second terminal may include sensing capability information of the second terminal, where the sensing capability information is used to indicate the sensing capability of the second terminal.

In some possible implementations, the above method may also include: S405, the first core network device receives a registration request message from the second terminal, the registration request message is used to request to register the second terminal to the first core network device; S406, the first core network device registers the second terminal; and S407, the first core network device sends a registration response message to the second terminal, the registration response message is used to indicate that the registration of the second terminal is complete.

In some possible implementations, the registration request message may carry the sensing capability information of the second terminal, where the sensing capability information is used to indicate the sensing capability of the second terminal.

In some possible implementations, the above method may further include: S408, the first core network device receives a sensing capability notification message from the second terminal, the sensing capability notification message carries sensing capability information of the second terminal, and the sensing capability information is used to indicate the sensing capability of the second terminal.

In some possible implementations, the above method may further include: S409, the first core network device receives a sensing response message from the sensing terminal, and the sensing response message carries sensing information obtained by the sensing terminal through sensing processing.

In some possible implementations, the location information may include cell identification information or tracking area identification information.

In some possible implementations, the first core network device may be a sensing application functional entity, and the second core network device may be an access and mobility management functional entity.

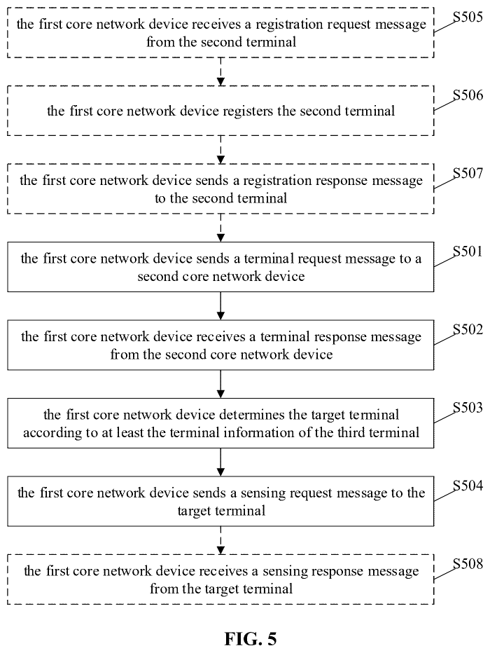

FIG. 5 is a flowchart of a second example of a method for providing sensing service in an embodiment of the present disclosure. Referring to FIG. 5, an embodiment of the present disclosure provides a method for providing a sensing service, which is applied to a first core network device. The method includes the steps shown in FIG. 5.

S501, the first core network device sends a terminal request message to a second core network device.

In the embodiment, the terminal request message carries the location information of the sensing service.

S502, the first core network device receives a terminal response message from the second core network device.

In the embodiment, the terminal response message carries terminal information of the third terminal, and the third terminal is associated with the location information and has a sensing capability to support the sensing service.

S503, the first core network device determines the sensing terminal according to at least the terminal information of the third terminal.

S504, the first core network device sends a sensing request message to the sensing terminal.

In the embodiment, the sensing request message is used to request the sensing terminal to perform sensing processing corresponding to the sensing service.

In some possible implementations, operation S503 in which the first core network device determines the sensing terminal based on terminal information of at least a third terminal may include: the first core network device obtains terminal information of the second terminal, where the second terminal is a terminal registered to the first core network device; and the first core network device determines the sensing terminal based on the terminal information of the third terminal and the terminal information of the second terminal.

In some possible implementations, the above method may also include: S505, the first core network device receives a registration request message from the second terminal, the registration request message is used to request to register the second terminal to the first core network device; S506, the first core network device registers the second terminal; and S507, the first core network device sends a registration response message to the second terminal, the registration response message is used to indicate that the registration of the second terminal is complete.

In some possible implementations, the above method may further include: S508, the first core network device receives a sensing response message from the sensing terminal, and the sensing response message carries sensing information obtained by the sensing terminal through sensing processing.

In some possible implementations, the location information may include cell identification information or tracking area identification information.

In some possible implementations, the first core network device may be a sensing application functional entity, and the second core network device may be an access and mobility management functional entity.

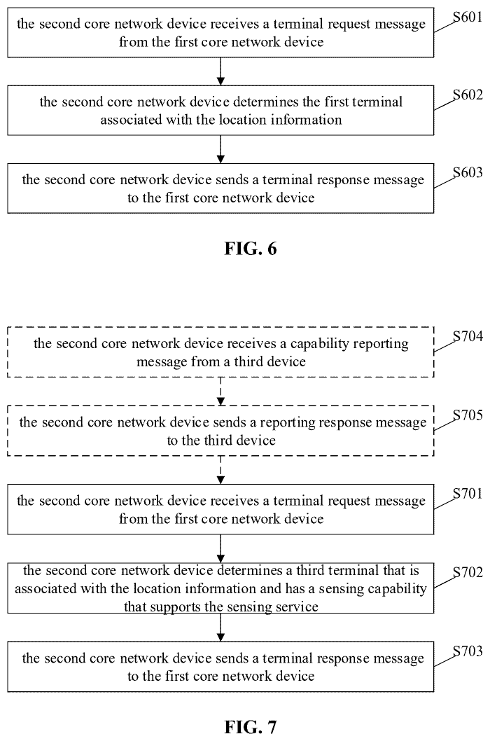

FIG. 6 is a flowchart of a third example of a method for providing sensing service in an embodiment of the present disclosure. Referring to FIG. 6, an embodiment of the present disclosure provides a method for providing a sensing service, which is applied to a second core network device. The method includes the steps shown in FIG. 6.

S601, the second core network device receives a terminal request message from the first core network device.

In the embodiment, the terminal request message carries the location information of the sensing service.

S602, the second core network device determines the first terminal associated with the location information.

S603, the second core network device sends a terminal response message to the first core network device.

In the embodiment, the terminal response message carries terminal information of the first terminal, and the terminal information of the first terminal is used by the first core network device to determine the sensing terminal, and the sensing terminal is used to perform sensing processing corresponding to the sensing service.

In some possible implementations, the location information may include cell identification information or tracking area identification information.

In some possible implementations, the first core network device may be a sensing application functional entity, and the second core network device may be an access and mobility management functional entity.

FIG. 7 is a flowchart of a fourth example of a method for providing a sensing service in an embodiment of the present disclosure. Referring to FIG. 7, an embodiment of the present disclosure provides a method for providing a sensing service, which is applied to a second core network device. The method includes the steps shown in FIG. 7.

S701, the second core network device receives a terminal request message from the first core network device.

In the embodiment, the terminal request message carries the location information of the sensing service.

S702, the second core network device determines a third terminal that is associated with the location information and has a sensing capability that supports the sensing service.

S703, the second core network device sends a terminal response message to the first core network device.

In the embodiment, the terminal response message carries terminal information of the third terminal, and the terminal information of the third terminal is used by the first core network device to determine the sensing terminal, and the sensing terminal is used to perform sensing processing corresponding to the sensing service.

In some possible implementations, the above method may also include: S704, the second core network device receives a capability reporting message from a third device, the capability reporting message carries sensing capability information of the third device, and the sensing capability information is used to indicate the sensing capability of the third device; and S705, the second core network device sends a reporting response message to the third device, and the reporting response message is used to indicate that the reporting of the sensing capability information is completed.

In some possible implementations, the location information may include cell identification information or tracking area identification information.

In some possible implementations, the first core network device may be a sensing application functional entity, and the second core network device may be an access and mobility management functional entity.

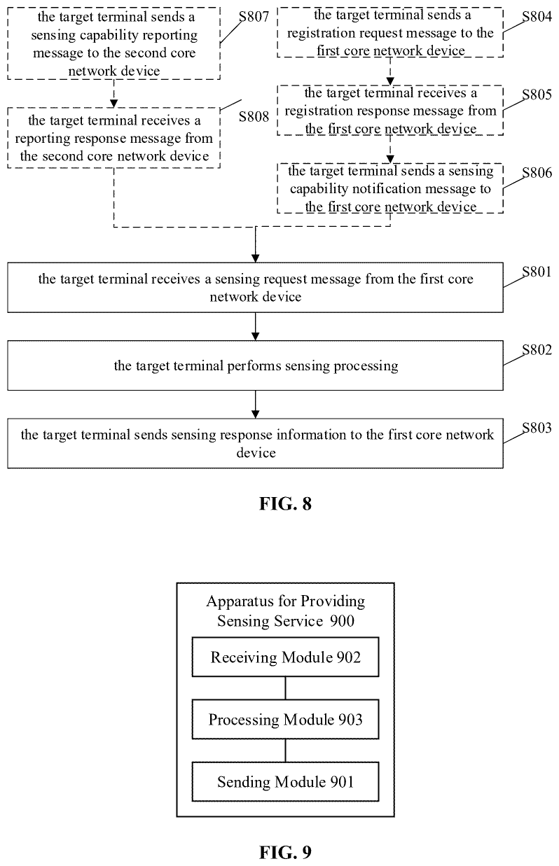

FIG. 8 is a flowchart of a fifth example of a method for providing a sensing service in an embodiment of the present disclosure. Referring to FIG. 8, an embodiment of the present disclosure provides a method for providing a sensing service, which is applied to a terminal device. The method includes the steps shown in FIG. 8.

S801, the sensing terminal receives a sensing request message from the first core network device.

In the embodiment, the sensing request message is used to request the sensing terminal to perform sensing processing corresponding to the sensing service, and the sensing terminal is associated with the location information of the sensing service.

S802, the sensing terminal performs sensing processing.

S803, the sensing terminal sends sensing response information to the first core network device.

In the embodiment, the sensing response information carries the sensing information obtained by the sensing processing.

In some possible implementations, the above method may also include: S804, the sensing terminal sends a registration request message to the first core network device, and the registration request message is used to request that the sensing terminal be registered to the first core network device; and S805, the sensing terminal receives a registration response message from the first core network device, and the registration response message is used to indicate that the registration of the sensing terminal is completed.

In some possible implementations, the registration request message may carry the sensing capability information of the sensing terminal, where the sensing capability information is used to indicate the sensing capability of the sensing terminal.

In some possible implementations, the above method may also include: S806, the sensing terminal sends a sensing capability notification message to the first core network device, the sensing capability notification message carries sensing capability information of the sensing terminal, and the sensing capability information is used to indicate the sensing capability of the sensing terminal.

In some possible implementations, the above method may also include: S807, the sensing terminal sends a sensing capability reporting message to the second core network device, the sensing capability reporting message carries the sensing capability information of the sensing terminal, and the sensing capability information is used to indicate the sensing capability of the sensing terminal; and S808, the sensing terminal receives a reporting response message from the second core network device, and the reporting response message is used to indicate that the reporting of the sensing capability information is completed.

In some possible implementations, the location information may include cell identification information or tracking area identification information.

In some possible implementations, the first core network device may be a sensing application functional entity, and the second core network device may be an access and mobility management functional entity.

FIG. 9 is a schematic diagram of an example of an apparatus for providing sensing service in an embodiment of the present disclosure. As shown in FIG. 9, the apparatus 900 may include: a sending module 901, a receiving module 902, and a processing module 903.

In one or more embodiments, the apparatus 900 may be a first core network device in a communication system, or a chip or system on chip in the first core network device, or a functional module in the first core network device for implementing the methods described in the above embodiments and their implementation methods. The apparatus may implement the functions performed by the first core network device in the above embodiments and their implementation methods, and these functions may be implemented by hardware executing corresponding software. These hardware or software include one or more modules corresponding to the above functions.

In one embodiment, the sending module 901 is used to send a terminal request message to the second core network device, and the terminal request message carries the location information of the sensing service. The receiving module 902 is used to receive a terminal response message from the second core network device, and the terminal response message carries the terminal information of the first terminal, and the first terminal is associated with the location information. The processing module 903 is used to determine the sensing terminal according to the terminal information of at least the first terminal. The sending module 901 is also used to send a sensing request message to the sensing terminal, and the sensing request message is used to request the sensing terminal to perform sensing processing corresponding to the sensing service.

In some possible implementations, the processing module 903 can be specifically used to: obtain terminal information of the second terminal, where the second terminal is a terminal registered to the first core network device; and determine the sensing terminal based on the terminal information of the first terminal and the terminal information of the second terminal.

In some possible implementations, the terminal information of the second terminal may include sensing capability information of the second terminal, where the sensing capability information is used to indicate the sensing capability of the second terminal.

In some possible implementations, the apparatus may further include a registration module 904. The receiving module 902 may also be used to receive a registration request message from the second terminal, the registration request message being used to request the second terminal to be registered to the first core network device. The registration module 904 may be used to register the second terminal. The sending module 901 may also be used to send a registration response message to the second terminal, the registration response message being used to indicate that the registration of the second terminal is complete.

In some possible implementations, the registration request message may carry the sensing capability information of the second terminal, where the sensing capability information is used to indicate the sensing capability of the second terminal.

In some possible implementations, the receiving module 902 may also be used to receive a sensing capability notification message from the second terminal, where the sensing capability notification message carries sensing capability information of the second terminal, and the sensing capability information is used to indicate the sensing capability of the second terminal.

In some possible implementations, the receiving module 902 may also be configured to receive a sensing response message from a sensing terminal, where the sensing response message carries sensing information obtained by the sensing terminal through sensing processing.

In some possible implementations, the location information may include cell identification information or tracking area identification information.

In some possible implementations, the first core network device may be a sensing application functional entity, and the second core network device may be an access and mobility management functional entity.

In one embodiment, the sending module 901 is used to send a terminal request message to the second core network device, and the terminal request message carries the location information of the sensing service. The receiving module 902 is used to receive a terminal response message from the second core network device, and the terminal response message carries the terminal information of a third terminal, and the third terminal is associated with the location information and has the sensing capability to support the sensing service. The processing module 903 is used to determine the sensing terminal based on the terminal information of at least the third terminal. The sending module 901 is also used to send a sensing request message to the sensing terminal, and the sensing request message is used to request the sensing terminal to perform sensing processing corresponding to the sensing service.

In some possible implementations, the processing module 903 can be specifically used to: obtain terminal information of the second terminal, where the second terminal is a terminal registered to the first core network device; and determine the sensing terminal based on the terminal information of the third terminal and the terminal information of the second terminal.

In some possible implementations, the apparatus may further include a registration module 904. The receiving module 902 may also be configured to receive a registration request message from the second terminal, the registration request message being used to request the second terminal to be registered to the first core network device. The registration module 904 may be configured to register the second terminal. The sending module 901 may also be configured to send a registration response message to the second terminal, the registration response message being used to indicate that the registration of the second terminal is complete.

In some possible implementations, the receiving module 902 may also be configured to receive a sensing response message from the sensing terminal, where the sensing response message carries sensing information obtained by the sensing terminal through sensing processing.

In some possible implementations, the location information may include cell identification information or tracking area identification information.

In some possible implementations, the first core network device may be a sensing application functional entity, and the second core network device may be an access and mobility management functional entity.

In one or more embodiments, the apparatus 900 may be a second core network device in a communication system, or a chip or system on chip in a second core network device, or a functional module in a second core network device for implementing the methods described in the above embodiments and their implementation methods. The apparatus may implement the functions performed by the second core network device in the above embodiments and their implementation methods, and these functions may be implemented by hardware executing corresponding software. These hardware or software include one or more modules corresponding to the above functions.

In one embodiment, the receiving module 902 is used to receive a terminal request message from a first core network device, the terminal request message carries location information of a sensing service. The processing module 903 is used to determine a first terminal associated with the location information. The sending module 901 is used to send a terminal response message to the first core network device, the terminal response message carries terminal information of the first terminal, the terminal information of the first terminal is used by the first core network device to determine a sensing terminal, and the sensing terminal is used to perform sensing processing corresponding to the sensing service.

In some possible implementations, the location information may include cell identification information or tracking area identification information.

In some possible implementations, the first core network device may be a sensing application functional entity, and the second core network device may be an access and mobility management functional entity.

In one embodiment, the receiving module 902 is used to receive a terminal request message from the first core network device, and the terminal request message carries the location information of the sensing service. The processing module 902 is used to determine a third terminal associated with the location information and having the sensing capability to support the sensing service. The sending module 901 is used to send a terminal response message to the first core network device, and the terminal response message carries the terminal information of the third terminal. The terminal information of the third terminal is used by the first core network device to determine the sensing terminal, and the sensing terminal is used to perform the sensing processing corresponding to the sensing service.

In some possible implementations, the receiving module 902 may also be used to receive a capability reporting message from a third device, the capability reporting message carrying the sensing capability information of the third device, the sensing capability information being used to indicate the sensing capability of the third device. The sending module 901 may also be used to send a reporting response message to the third device, the reporting response message being used to indicate that the sensing capability information reporting is complete.

In some possible implementations, the location information may include cell identification information or tracking area identification information.

In some possible implementations, the first core network device may be a sensing application functional entity, and the second core network device may be an access and mobility management functional entity.

In one or more embodiments, the apparatus 900 may be a terminal device in a communication system, or a chip or system on chip in a terminal device, or a functional module in a terminal device for implementing the methods described in the above embodiments and their implementations. The apparatus may implement the functions performed by the terminal device in the above embodiments and their implementations, and these functions may be implemented by hardware executing corresponding software. These hardware or software include one or more modules corresponding to the above functions.

In one embodiment, the receiving module 902 is used to receive a sensing request message from the first core network device, the sensing request message is used to request the sensing terminal to perform sensing processing corresponding to the sensing service, and the sensing terminal is associated with the location information of the sensing service. The processing module 903 is used to perform sensing processing. The sending module 901 is used to send sensing response information to the first core network device, and the sensing response information carries the sensing information obtained by the sensing processing.

In some possible implementations, the sending module 901 may also be used to send a registration request message to the first core network device, the registration request message being used to request the sensing terminal to be registered to the first core network device. The receiving module 902 may also be used to receive a registration response message from the first core network device, the registration response message being used to indicate that the sensing terminal registration is complete.

In some possible implementations, the registration request message may carry the sensing capability information of the sensing terminal, where the sensing capability information is used to indicate the sensing capability of the sensing terminal.

In some possible implementations, the sending module 901 may also be used to send a sensing capability notification message to the first core network device, where the sensing capability notification message carries sensing capability information of the sensing terminal, and the sensing capability information is used to indicate the sensing capability of the sensing terminal.

In some possible implementations, the sending module 901 may also be used to send a sensing capability reporting message to the second core network device, the sensing capability reporting message carries the sensing capability information of the sensing terminal, and the sensing capability information is used to indicate the sensing capability of the sensing terminal. The receiving module 902 may also be used to receive a reporting response message from the second core network device, and the reporting response message is used to indicate that the reporting of the sensing capability information is completed.

In some possible implementations, the location information may include cell identification information or tracking area identification information.

In some possible implementations, the first core network device may be a sensing application functional entity, and the second core network device may be an access and mobility management functional entity.

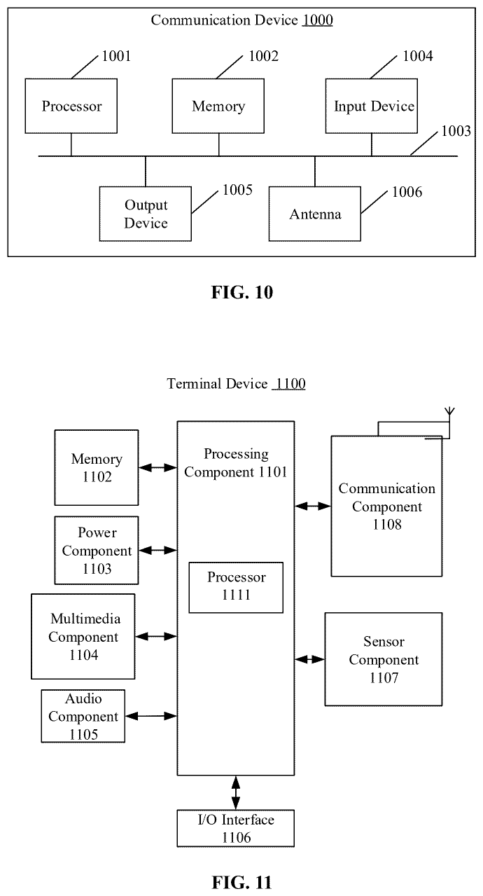

Based on the same inventive concept, an embodiment of the present disclosure provides a communication device. The communication device may be a terminal device or a core network device described in one or more of the above embodiments. FIG. 10 is a schematic diagram of the structure of a communication device in an embodiment of the present disclosure. Referring to FIG. 10, a communication device 1000 uses general computer hardware, including a processor 1001, a memory 1002, a bus 1003, an input device 1004, and an output device 1005.

In some possible implementations, the memory 1002 may include computer storage media in the form of volatile and/or non-volatile memory, such as read-only memory and/or random access memory. The memory 1002 may store an operating system, application programs, other program modules, executable code, program data, user data, etc.

The input device 1004 can be used to input commands and information to the communication device, such as a keyboard or a pointing device, such as a mouse, trackball, touch pad, microphone, joystick, game pad, satellite TV antenna, scanner or similar device. These input devices can be connected to processor 1001 via bus 1003.

The output device 1005 can be used for outputting information from the communication device. In addition to the monitor, the output device 1005 can also be other peripheral output devices, such as speakers and/or printing devices. These output devices can also be connected to the processor 1001 through the bus 1003.

The communication device may be connected to a network, such as a local area network (LAN), via antenna 1006. In a networked environment, the computer-executable instructions stored in the control device may be stored in a remote storage device, rather than being limited to local storage.

When the processor 1001 in the communication device executes the executable code or application stored in the memory 1002, the communication device executes the method for providing wireless sensing service of the terminal device or core network device in the above embodiments. The specific execution process refers to the above embodiments and will not be repeated here.

In addition, the memory 1002 stores computer-executable instructions for implementing the functions of the functional modules in FIG. 9. The functions/implementation processes of the functional modules in FIG. 9 can be implemented by the processor 1001 in FIG. 10 calling the computer-executable instructions stored in the memory 1002. For specific implementation processes and functions, refer to the above-mentioned related embodiments.

Based on the same inventive concept, the embodiment of the present disclosure provides a terminal device, which is consistent with the terminal device in one or more of the above embodiments. Optionally, the terminal device can be a mobile phone, a computer, a digital broadcast terminal, a message transceiver device, a game console, a tablet device, a medical device, a fitness device, a personal digital assistant, etc.

FIG. 11 is a schematic diagram of the structure of a terminal device in an embodiment of the present disclosure. As shown in FIG. 11, the terminal device 1100 may include one or more of the following components: a processing component 1101, a memory 1102, a power component 1103, a multimedia component 1104, an audio component 1105, an input/output (I/O) Interface 1106, a sensor component 1107, and a communication component 1108.

The processing component 1101 generally controls the overall operations of the terminal device 1100, such as operations associated with display, telephone calls, data communications, camera operations, and recording operations. The processing component 1101 may include one or more processors 1111 to execute instructions to complete all or part of the steps of the above method. Additionally, processing component 1101 may include one or more modules that facilitate interaction between processing component 1101 and other components. For example, processing component 1101 may include a multimedia module to facilitate interaction between multimedia component 1108 and processing component 1101.

The memory 1102 is configured to store various types of data to support operations at the terminal device 1100. Examples of such data include instructions for any application or method operating on the terminal device 1100, contact data, phonebook data, messages, pictures, videos, etc. The memory 1102 can be realized by any type of volatile or non-volatile storage device or their combination, such as static random access memory (SRAM), electrically erasable programmable read only memory (EEPROM), erasable programmable read only memory (EPROM), programmable read only memory (PROM), read only memory (ROM), magnetic memory, flash memory, magnetic disk or optical disk.

The power supply component 1103 provides power to various components of the terminal device 1100. The power component 1103 may include a power management system, one or more power supplies, and other components associated with generating, managing, and distributing power for terminal device 1100.

The multimedia component 1104 includes a screen providing an output interface between the terminal device 1100 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense a boundary of a touch or a swipe action, but also detect duration and pressure associated with the touch or swipe operation. In some embodiments, the multimedia component 1104 includes a front camera and/or a rear camera. When the terminal device 1100 is in an operation mode, such as a photographing mode or a video mode, the front camera and/or the rear camera can receive external multimedia data. Each front camera and rear camera can be a fixed optical lens system or have focal length and optical zoom capability.

The audio component 1105 is configured to output and/or input audio signals. For example, the audio component 1105 includes a microphone (MIC), which is configured to receive an external audio signal when the terminal device 1100 is in an operation mode, such as a call mode, a recording mode and a voice recognition mode. Received audio signals may be further stored in memory 1102 or sent via communication component 1108. In some embodiments, the audio component 1105 also includes a speaker for outputting audio signals.

The I/O interface 1106 provides an interface between the processing component 1101 and a peripheral interface module, which may be a keyboard, a click wheel, a button, and the like. These buttons may include, but are not limited to: a home button, volume buttons, start button, and lock button.

The sensor component 1107 includes one or more sensors for providing terminal device 1100 with various aspects of status assessment. For example, the sensor component 1107 can detect the open/closed state of the terminal device 1100, the relative positioning of components, such as the display and the keypad of the terminal device 1100, the sensor component 1107 can also detect the terminal device 1100 or a change in the position of a component of the terminal device 1100, the presence or absence of user's contact with the terminal device 1100, the change of orientation or acceleration/deceleration of the terminal device 1100 and the temperature change of the terminal device 1100. The sensor component 1107 may include a proximity sensor configured to detect the presence of nearby objects in the absence of any physical contact. The sensor component 1107 may also include an optical sensor, such as a CMOS or CCD image sensor, for use in imaging applications. In some embodiments, the sensor component 1107 may also include an acceleration sensor, a gyroscope sensor, a magnetic sensor, a pressure sensor or a temperature sensor.

The communication component 1108 is configured to facilitate wired or wireless communication between the terminal device 1100 and other devices. The terminal device 1100 can access a wireless network based on communication standards, such as Wi-Fi, 2G or 3G, or a combination thereof. In an exemplary embodiment, the communication component 1108 receives broadcast signals or broadcast related information from an external broadcast management system via a broadcast channel. In an exemplary embodiment, the communication component 1108 also includes a near field communication (NFC) module to facilitate short-range communication. For example, the NFC module can be implemented based on radio frequency identification (RFID) technology, infrared data association (IrDA) technology, ultra wideband (UWB) technology, bluetooth (BT) technology and other technologies.

In an exemplary embodiment, terminal device 1100 may be implemented by one or more application specific integrated circuits (ASIC), digital signal processors (DSP), digital signal processing devices (DSPD), programmable logic devices (PLD), field programmable gate array (FPGA), controllers, microcontrollers, microprocessors or other electronic components for performing the method described above.

Based on the same inventive concept, an embodiment of the present disclosure provides a network device, which is consistent with the network device in one or more of the above embodiments.

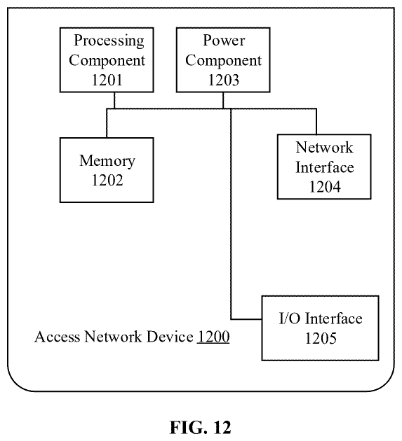

FIG. 12 is a schematic diagram of the structure of a network device in an embodiment of the present disclosure. The network device may be an access network device or a core network device. Referring to FIG. 12, the network device 1200 may include a processing component 1201, which further includes one or more processors, and a memory resource represented by a memory 1202, for storing instructions executable by the processing component 1201, such as an application. The application stored in the memory 1202 may include one or more modules, each corresponding to a set of instructions. In addition, the processing component 1201 is configured to execute instructions to execute any of the aforementioned methods applied to the network device.

The network device 1200 may also include a power component 1203 configured to perform power management of network device 1200, a wired or wireless network interface 1204 configured to connect network device 1200 to a network, and an input-output (I/O) interface 1205. The network device 1200 can operate based on an operating system stored in the memory 1202, such as Windows Server™, Mac OS X™, Unix™, Linux™, FreeBSD™ or the like.

The present disclosure provides a method, apparatus, device and storage medium for providing a sensing service, so as to identify a terminal located at a specific location and having the sensing capability required for the sensing service, thereby realizing wireless sensing at the specific location.

According to a first aspect of the present disclosure, a method for providing a sensing service is provided. The method can be applied to a first core network device in a communication system. The above method includes: the first core network device sends a terminal request message to the second core network device, and the terminal request message carries the location information of the sensing service; the first core network device receives a terminal response message from the second core network device, and the terminal response message carries the terminal information of the first terminal, and the first terminal is associated with the location information; the first core network device determines the sensing terminal according to at least the terminal information of the first terminal; the first core network device sends a sensing request message to the sensing terminal, and the sensing request message is used to request the sensing terminal to perform sensing processing corresponding to the sensing service.

In some possible implementations, the operation of the first core network device determining the sensing terminal according to at least the terminal information of the first terminal may include: obtaining, by the first core network device, terminal information of a second terminal, wherein the second terminal is a terminal registered to the first core network device; and determining, by the first core network device, the sensing terminal according to the terminal information of the first terminal and the terminal information of the second terminal.

In some possible implementations, the terminal information of the second terminal may include sensing capability information of the second terminal, and the sensing capability information is used to indicate a sensing capability of the second terminal.

In some possible implementations, the method may further include: receiving, by the first core network device, a registration request message from the second terminal, wherein the registration request message is used to request registering the second terminal to the first core network device; registering, by the first core network device, the second terminal; and sending, by the first core network device, a registration response message to the second terminal, wherein the registration response message is used to indicate that registration of the second terminal is completed.

In some possible implementations, a sensing capability information of the second terminal may be carried by the registration request message, and the sensing capability information is used to indicate the sensing capability of the second terminal.

In some possible implementations, the method may further include: receiving, by the first core network device, a sensing capability notification message from the second terminal, wherein a sensing capability information of the second terminal is carried by the sensing capability notification message, and the sensing capability information is used to indicate the sensing capability of the second terminal.

In some possible implementations, the method may further include: receiving, by the first core network device, a sensing response message from the sensing terminal, wherein sensing information obtained by the sensing terminal through the sensing processing is carried by the sensing response message.

In some possible implementations, the location information may include cell identification information or tracking area identification information.

In some possible implementations, the first core network device may be a sensing application function entity, and the second core network device may be an access and mobility management function entity.

According to a second aspect of the present disclosure, a method for providing sensing service is provided. The method may be applied to a second core network device of the communication system. The above method includes: receiving, the second core network device, a terminal request message from a first core network device, wherein location information of a sensing service is carried by the terminal request message; determining, by the second core network device, a first terminal associated with the location information; sending, by the second core network device, a terminal response message to the first core network device, wherein terminal information of the first terminal is carried by the terminal response message, the terminal information of the first terminal is used by the first core network device to determine the sensing terminal, and the sensing terminal is used to perform sensing processing corresponding to the sensing service.

In some possible implementations, the location information may include cell identification information or tracking area identification information.

In some possible implementations, the first core network device may be a sensing application function entity, and the second core network device may be an access and mobility management function entity.

According to a third aspect of the present disclosure, a method for providing sensing service is provided. The method may be applied to a first core network device in the communication system. The above method includes: sending, by the first core network device, a terminal request message to a second core network device, wherein location information of a sensing service is carried by the terminal request message; receiving, by the first core network device, a terminal response message from the second core network device, wherein terminal information of a third terminal is carried by the terminal response message, and the third terminal is associated with the location information and has a sensing capability that supports the sensing service; determining, by the first core network device, a sensing terminal according to at least the terminal information of the third terminal; and sending, by the first core network device, a sensing request message to the sensing terminal, wherein the sensing request message is used to request the sensing terminal to perform sensing processing corresponding to the sensing service.

In some possible implementations, the step of the first core network device determining the sensing terminal according to at least the terminal information of the third terminal may include: obtaining, by the first core network device, terminal information of a second terminal, wherein the second terminal is a terminal registered to the first core network device; and determining, by the first core network device, the sensing terminal according to the terminal information of the third terminal and the terminal information of the second terminal.

In some possible implementations, the method may further include: receiving, by the first core network device, a registration request message from the second terminal, wherein the registration request message is used to request registering the second terminal to the first core network device; registering, by the first core network device, the second terminal; and sending, by the first core network device, a registration response message to the second terminal, wherein the registration response message is used to indicate that registration of the second terminal is completed.

In some possible implementations, the method may further include: receiving, by the first core network device, a sensing response message from the sensing terminal, wherein sensing information obtained by the sensing terminal through the sensing processing is carried by the sensing response message.

In some possible implementations, the location information may include cell identification information or tracking area identification information.

In some possible implementations, the first core network device may be a sensing application function entity, and the second core network device may be an access and mobility management function entity.

According to a fourth aspect of the present disclosure, a method for providing sensing service is provided. The method may be applied to a second core network device in the communication system. The above method includes: receiving, a second core network device, a terminal request message from a first core network device, wherein location information of a sensing service is carried by the terminal request message; determining, by the second core network device, a third terminal associated with the location information and having a sensing capability that supports the sensing service; and sending, by the second core network device, a terminal response message to the first core network device, wherein terminal information of the third terminal is carried by the terminal response message, the terminal information of the third terminal is used by the first core network device to determine the sensing terminal, and the sensing terminal is used to perform sensing processing corresponding to the sensing service.

In some possible implementations, the method may further include: receiving, by the second core network device, a capability reporting message from the third device, wherein sensing capability information of the third device is carried by the capability reporting message, and wherein the sensing capability information is used to indicate the sensing capability of the third device; and sending, by the second core network device, a reporting response message to the third device, wherein the reporting response message is used to indicate that reporting of the sensing capability information is completed.

In some possible implementations, the location information may include cell identification information or tracking area identification information.

In some possible implementations, the first core network device may be a sensing application function entity, and the second core network device may be an access and mobility management function entity.

According to a fifth aspect of the present disclosure, a method for providing sensing service is provided. The method may be applied to a terminal device in the communication system. The above method includes: receiving, by a sensing terminal, a sensing request message from a first core network device, wherein the sensing request message is used to request the sensing terminal to perform a sensing process corresponding to a sensing service, and the sensing terminal is associated with location information of the sensing service; performing, by the sensing terminal, the sensing processing; and sending, by the sensing terminal, sensing response information to the first core network device, and sensing information obtained by performing the sensing processing is carried by the sensing response information.

In some possible implementations, the method may further include: sending, by the sensing terminal, a registration request message to the first core network device, wherein the registration request message is used to request registering the sensing terminal to the first core network device; and receiving, by the sensing terminal, a registration response message from the first core network device, wherein the registration response message is used to indicate that registration of the sensing terminal is completed.

In some possible implementations, sensing capability information of the sensing terminal may be carried by the registration request message, and the sensing capability information is used to indicate a sensing capability of the sensing terminal.

In some possible implementations, the method may further include: sending, by the sensing terminal, a sensing capability notification message to the first core network device, wherein sensing capability information of the sensing terminal is carried by the sensing capability notification message, and the sensing capability information is used to indicate a sensing capability of the sensing terminal.

In some possible implementations, the method may further include: sending, by the sensing terminal, a sensing capability reporting message to a second core network device, wherein sensing capability information of the sensing terminal is carried by the sensing capability reporting message, and the sensing capability information is used to indicate a sensing capability of the sensing terminal; and receiving, by the sensing terminal, a reporting response message from the second core network device, wherein the reporting response message is used to indicate that reporting of the sensing capability information is completed.

In some possible implementations, the location information may include cell identification information or tracking area identification information.

In some possible implementations, the method may further include: the first core network device may be a sensing application function entity, and the second core network device may be an access and mobility management function entity.

According to a sixth aspect of the present disclosure, an apparatus for providing sensing service is provided. The apparatus may be disposed on a first core network device. The above apparatus includes a sending module, a receiving module, and a determining module. The sending module is configured to send a terminal request message to a second core network device, wherein location information of a sensing service is carried by the terminal request message. The receiving module is configured to receive a terminal response message from the second core network device, wherein terminal information of a first terminal is carried by the terminal response message, and the first terminal is associated with the location information. The determining module is configured to determine a sensing terminal according to at least the terminal information of the first terminal. The sending module is further configured to send a sensing request message to the sensing terminal, wherein the sensing request message is used to request the sensing terminal to perform sensing processing corresponding to the sensing service.

In some possible implementations, the processing module may be further configured to: obtain terminal information of a second terminal, wherein the second terminal is a terminal registered to the first core network device; and determine the sensing terminal according to the terminal information of the first terminal and the terminal information of the second terminal.

In some possible implementations, the terminal information of the second terminal may include sensing capability information of the second terminal, and the sensing capability information is used to indicate a sensing capability of the second terminal.

In some possible implementations, the apparatus may further include a registering module. The receiving module is further configured to receive a registration request message from the second terminal, wherein the registration request message is used to request registering the second terminal to the first core network device. The registering module may be configured to register the second terminal. The sending module is further configured to send a registration response message to the second terminal, wherein the registration response message is used to indicate that registration of the second terminal is completed.

In some possible implementations, a sensing capability information of the second terminal may be carried by the registration request message, and the sensing capability information is used to indicate the sensing capability of the second terminal.

In some possible implementations, the receiving module may be further configured to receive a sensing capability notification message from the second terminal, wherein a sensing capability information of the second terminal is carried by the sensing capability notification message, and the sensing capability information is used to indicate the sensing capability of the second terminal.

In some possible implementations, the receiving module may be further configured to receive a sensing response message from the sensing terminal, wherein sensing information obtained by the sensing terminal through the sensing processing is carried by the sensing response message.

In some possible implementations, the location information may include cell identification information or tracking area identification information.

In some possible implementations, the first core network device may be a sensing application function entity, and the second core network device may be an access and mobility management function entity.

According to a seventh aspect of the present disclosure, an apparatus for providing sensing service is provided. The apparatus may be disposed on a second core network device. The above apparatus includes a receiving module, a determining module, and a sending module. The receiving module is configured to receive a terminal request message from a first core network device, wherein location information of a sensing service is carried by the terminal request message. The determining module is configured to determine a first terminal associated with the location information. The sending module is configured to send a terminal response message to the first core network device, wherein terminal information of the first terminal is carried by the terminal response message, the terminal information of the first terminal is used by the first core network device to determine the sensing terminal, and the sensing terminal is used to perform sensing processing corresponding to the sensing service.

In some possible implementations, the location information may include cell identification information or tracking area identification information.

In some possible implementations, the first core network device may be a sensing application function entity, and the second core network device may be an access and mobility management function entity.

According to an eighth aspect of the present disclosure, an apparatus for providing sensing service is provided. The apparatus may be disposed on a first core network device. The above apparatus includes a sending module, a receiving module, and a determining module. The sending module is configured to send a terminal request message to a second core network device, wherein location information of a sensing service is carried by the terminal request message. The receiving module is configured to receive a terminal response message from the second core network device, wherein terminal information of a third terminal is carried by the terminal response message, and the third terminal is associated with the location information and has a sensing capability that supports the sensing service. The determining module is configured to determine a sensing terminal according to at least the terminal information of the third terminal. The sending module is further configured to send a sensing request message to the sensing terminal, wherein the sensing request message is used to request the sensing terminal to perform sensing processing corresponding to the sensing service.

In some possible implementations, the processing module is further configured to: obtain terminal information of a second terminal, wherein the second terminal is a terminal registered to the first core network device; and determine the sensing terminal according to the terminal information of the third terminal and the terminal information of the second terminal.

In some possible implementations, the apparatus may further include a registering module. The receiving module is further configured to receive a registration request message from the second terminal, wherein the registration request message is used to request registering the second terminal to the first core network device. The registering module may be configured to register the second terminal. The sending module is further configured to send a registration response message to the second terminal, wherein the registration response message is used to indicate that registration of the second terminal is completed.

In some possible implementations, the receiving module may be further configured to receive a sensing response message from the sensing terminal, wherein sensing information obtained by the sensing terminal through the sensing processing is carried by the sensing response message.

In some possible implementations, the location information may include cell identification information or tracking area identification information.

In some possible implementations, the first core network device may be a sensing application function entity, and the second core network device may be an access and mobility management function entity.

According to a ninth aspect of the present disclosure, an apparatus for providing sensing service is provided. The apparatus may be disposed on a second core network device. The above apparatus includes a receiving module, a determining module, and a sending module. The receiving module is configured to receive a terminal request message from a first core network device, wherein location information of a sensing service is carried by the terminal request message. The determining module is configured to determine a third terminal associated with the location information and having a sensing capability that supports the sensing service. The sending module is configured to send a terminal response message to the first core network device, wherein terminal information of the third terminal is carried by the terminal response message, the terminal information of the third terminal is used by the first core network device to determine the sensing terminal, and the sensing terminal is used to perform sensing processing corresponding to the sensing service.

In some possible implementations, the receiving module may be further configured to receive a capability reporting message from the third device, wherein sensing capability information of the third device is carried by the capability reporting message, and wherein the sensing capability information is used to indicate the sensing capability of the third device. The sending module may be further configured to send a reporting response message to the third device, wherein the reporting response message is used to indicate that reporting of the sensing capability information is completed.

In some possible implementations, the location information may include cell identification information or tracking area identification information.

In some possible implementations, the first core network device may be a sensing application function entity, and the second core network device may be an access and mobility management function entity.

According to a tenth aspect of the present disclosure, an apparatus for providing sensing service is provided. The apparatus may be disposed on a terminal device. The above apparatus includes a receiving module, a processing module, and a sending module. The receiving module is configured to receive a sensing request message from a first core network device, wherein the sensing request message is used to request the sensing terminal to perform a sensing process corresponding to a sensing service, and the sensing terminal is associated with location information of the sensing service. The processing module is configured to perform the sensing processing. The sensing module is configured to send sensing response information to the first core network device, and sensing information obtained by performing the sensing processing is carried by the sensing response information.

In some possible implementations, the sending module may be further configured to send a registration request message to the first core network device, wherein the registration request message is used to request registering the sensing terminal to the first core network device. The receiving module may be further configured to receive a registration response message from the first core network device, wherein the registration response message is used to indicate that registration of the sensing terminal is completed.

In some possible implementations, sensing capability information of the sensing terminal may be carried by the registration request message, and the sensing capability information is used to indicate a sensing capability of the sensing terminal.

In some possible implementations, the sending module may be further configured to send a sensing capability notification message to the first core network device, wherein sensing capability information of the sensing terminal is carried by the sensing capability notification message, and the sensing capability information is used to indicate a sensing capability of the sensing terminal.

In some possible implementations, the sending module may be further configured to send a sensing capability reporting message to a second core network device, wherein sensing capability information of the sensing terminal is carried by the sensing capability reporting message, and the sensing capability information is used to indicate a sensing capability of the sensing terminal. The receiving module may be further configured to receive a reporting response message from the second core network device, wherein the reporting response message is used to indicate that reporting of the sensing capability information is completed.

In some possible implementations, the location information may include cell identification information or tracking area identification information.

In some possible implementations, the method may further include: the first core network device may be a sensing application function entity, and the second core network device may be an access and mobility management function entity.

According to an eleventh aspect of the present disclosure, a core network device is provided. The above core network device includes: a memory, configured to store computer executable instructions; and a processor, connected to the memory and configured to execute the computer executable instructions stored on the memory to implement the method according to any one of the first aspect to the fourth aspect and their possible implantations.

According to a twelfth aspect of the present disclosure, a terminal is provided. The above terminal includes: a memory, configured to store computer executable instructions; and a processor, connected to the memory and configured to execute the computer executable instructions stored on the memory to implement the method according to any one of the fifth aspect and its possible implantations.

According to a thirteenth aspect of the present disclosure, a computer readable storage medium is provided, the computer readable storage medium has computer executable instructions stored therein; when the computer executable instructions are executable by a processor in a computer, the method according to any one of the first aspect to the fifth aspect and their possible implantations is implemented.

According to a fourteenth aspect of the present disclosure, a computer program or a computer program product is provided. When the computer program product is executed on a computer, the computer implements a method as described in any one of the first to fifth aspects and possible implementations thereof.

In the present disclosure, a terminal for wireless sensing is determined based on the location information of the sensing service and the sensing capability information of the terminal, so that the determined terminal can be in a specific location corresponding to the sensing service and implement sensing processing corresponding to the sensing service, thereby realizing wireless sensing at the specific location.

It should be understood that the fifth to fourteenth aspects of the present disclosure are consistent with the technical solutions of the first to fifth aspects of the present disclosure, and the beneficial effects achieved by each aspect and the corresponding feasible implementation methods are similar, which will not be repeated.

Based on the same inventive concept, an embodiment of the present disclosure further provides a computer-readable storage medium, in which instructions are stored; when the instructions are executed on a computer, the instructions are used to execute the method described in one or more of the above embodiments.

Based on the same inventive concept, the embodiments of the present disclosure further provide a computer program or a computer program product. When the computer program product is executed on a computer, the computer implements the method described in one or more of the above embodiments.

Other embodiments of the invention will be readily apparent to those skilled in the art from consideration of the specification and practice of the invention disclosed herein. This disclosure is intended to cover any modification, use or adaptation of the present invention, these modifications, uses or adaptations follow the general principles of the present invention and include common knowledge or conventional technical means in the technical field not disclosed in this disclosure. The specification and examples are to be considered exemplary only, with a true scope and spirit of the invention being indicated by the following claims.

It should be understood that the present invention is not limited to the precise constructions which have been described above and shown in the accompanying drawings, and various modifications and changes may be made without departing from the scope thereof. The scope of the invention is limited only by the appended claims.

1. A method for providing sensing service, comprising:
sending, by a first core network device, a terminal request message to a second core network device, wherein location information of a sensing service is carried by the terminal request message;
receiving, by the first core network device, a terminal response message from the second core network device, wherein terminal information of a first terminal is carried by the terminal response message, and the first terminal is associated with the location information, or wherein terminal information of a third terminal is carried by the terminal response message, and the third terminal is associated with the location information and has a sensing capability that supports the sensing service;
determining, by the first core network device, a sensing terminal according to at least the terminal information of the first terminal or the third terminal; and
sending, by the first core network device, a sensing request message to the sensing terminal, wherein the sensing request message is used to request the sensing terminal to perform sensing processing corresponding to the sensing service.

2. The method according to claim 1, wherein the first core network device determining the sensing terminal according to at least the terminal information of the first terminal or the third terminal, comprising:
obtaining, by the first core network device, terminal information of a second terminal, wherein the second terminal is a terminal registered to the first core network device; and
determining, by the first core network device, the sensing terminal according to the terminal information of the first terminal or the third terminal and the terminal information of the second terminal.

3. The method according to claim 2, wherein the terminal information of the second terminal comprises sensing capability information of the second terminal, and the sensing capability information is used to indicate a sensing capability of the second terminal.

4. The method according to claim 2, further comprising:
receiving, by the first core network device, a registration request message from the second terminal, wherein the registration request message is used to request registering the second terminal to the first core network device;
registering, by the first core network device, the second terminal; and
sending, by the first core network device, a registration response message to the second terminal, wherein the registration response message is used to indicate that registration of the second terminal is completed.

5. The method according to claim 4, wherein a sensing capability information of the second terminal is carried by the registration request message, and the sensing capability information is used to indicate the sensing capability of the second terminal.

6. The method according to claim 4, further comprising:
receiving, by the first core network device, a sensing capability notification message from the second terminal, wherein a sensing capability information of the second terminal is carried by the sensing capability notification message, and the sensing capability information is used to indicate the sensing capability of the second terminal.

7. The method according to claim 1, further comprising:
receiving, by the first core network device, a sensing response message from the sensing terminal, wherein sensing information obtained by the sensing terminal through the sensing processing is carried by the sensing response message.

8. The method according to any one of claims 1 to 7claim 1, wherein the location information comprises cell identification information or tracking area identification information.

9. The method according to any one of claims 1 to 7claim 1, wherein the first core network device is a sensing application function entity SAF, and the second core network device is an access and mobility management function entity AMF.

10. A method for providing sensing service, comprising:
receiving, a second core network device, a terminal request message from a first core network device, wherein location information of a sensing service is carried by the terminal request message;
determining, by the second core network device, a first terminal associated with the location information or a third terminal associated with the location information and having a sensing capability that supports the sensing service;
sending, by the second core network device, a terminal response message to the first core network device, wherein terminal information of the first terminal or the third terminal is carried by the terminal response message, the terminal information of the first terminal or the third terminal is used by the first core network device to determine the sensing terminal, and the sensing terminal is used to perform sensing processing corresponding to the sensing service.

11. The method according to claim 10, wherein the location information comprises cell identification information or tracking area identification information.

12-19. (canceled)

20. The method according to claim 1910, further comprising:
receiving, by the second core network device, a capability reporting message from the third terminal, wherein sensing capability information of the third device is carried by the capability reporting message, and wherein the sensing capability information is used to indicate the sensing capability of the third device; and
sending, by the second core network device, a reporting response message to the third device, wherein the reporting response message is used to indicate that reporting of the sensing capability information is completed.

21.-22. (canceled)

23. A method for providing sensing service, comprising:
receiving, by a sensing terminal, a sensing request message from a first core network device, wherein the sensing request message is used to request the sensing terminal to perform a sensing process corresponding to a sensing service, and the sensing terminal is associated with location information of the sensing service;
performing, by the sensing terminal, the sensing processing; and
sending, by the sensing terminal, sensing response information to the first core network device, and sensing information obtained by performing the sensing processing is carried by the sensing response information.

24. The method according to claim 23, further comprising:
sending, by the sensing terminal, a registration request message to the first core network device, wherein the registration request message is used to request registering the sensing terminal to the first core network device; and
receiving, by the sensing terminal, a registration response message from the first core network device, wherein the registration response message is used to indicate that registration of the sensing terminal is completed.

25. The method according to claim 24, wherein sensing capability information of the sensing terminal is carried by the registration request message, and the sensing capability information is used to indicate a sensing capability of the sensing terminal.

26. The method according to claim 24, further comprising:
sending, by the sensing terminal, a sensing capability notification message to the first core network device, wherein sensing capability information of the sensing terminal is carried by the sensing capability notification message, and the sensing capability information is used to indicate a sensing capability of the sensing terminal.

27. The method according to claim 24, further comprising:
sending, by the sensing terminal, a sensing capability reporting message to a second core network device, wherein sensing capability information of the sensing terminal is carried by the sensing capability reporting message, and the sensing capability information is used to indicate a sensing capability of the sensing terminal; and
receiving, by the sensing terminal, a reporting response message from the second core network device, wherein the reporting response message is used to indicate that reporting of the sensing capability information is completed.

28-29. (canceled)

30. An apparatus for providing sensing service, comprising:
a memory, configured to store computer executable instructions; and
a processor, connected to the memory and configured to execute the computer executable instructions stored on the memory to implement the method according to claim 1.

31. An apparatus for providing sensing service, comprising:
a memory, configured to store computer executable instructions; and
a processor, connected to the memory and configured to execute the computer executable instructions stored on the memory to implement the method according to claim 10.

32. An apparatus for providing sensing service, comprising:
a memory, configured to store computer executable instructions; and
a processor, connected to the memory and configured to execute the computer executable instructions stored on the memory to implement the method according to claim 23.

33-36. (canceled)
